(19) United States
(12) Patent Application Publication
(10) Pub. No.: US 2026/0138012 A1
(43) Pub. Date: May 21, 2026

(54) OPERATION PROCESSING APPARATUS, OPERATION PROCESSING METHOD, AND COMPUTER PROGRAM

(71) Applicant: Sony Interactive Entertainment Inc., Tokyo (JP)

(72) Inventors: Tomoyuki Okubo, Saitama (JP); Takashi Enokihara, Ibaraki (JP); Takafumi Ogura, Chiba (JP)

(21) Appl. No.: 19/449,202

(22) Filed: Jan. 14, 2026

Related U.S. Application Data
(63) Continuation of application No. PCT/JP2024/022756, filed on Jun. 24, 2024.

(30) Foreign Application Priority Data
Jul. 14, 2023 (JP) 2023-115983

(51) Int. Cl. A63F 13/42

(52) U.S. Cl. CPC A63F 13/42

(57) ABSTRACT

A controller 18 acquires values related to operation amounts of a plurality of analog sticks 20 (analog stick 20a, analog stick 20b, analog stick 20c) to which a user’s operation is input. When a value related to an operation amount of each of the plurality of analog sticks 20 is within a range that is considered to be in a stationary state, the controller 18 determines a representative analog stick 20 from among the plurality of analog sticks 20 based on a predetermined rule. The controller 18 generates operation information based on a value related to an operation amount for the representative analog stick 20.

### CROSS-REFERENCE TO RELATED APPLICATIONS

This application is a bypass continuation application of PCT Application No. PCT/JP2024/022756, filed on June 24, 2024, which claims priority to Japanese Patent Application No. 2023-115983, filed on July 14, 2023, the contents of which are hereby incorporated by reference.

### TECHNICAL FIELD

The present invention relates to data processing technology, particularly to an operation processing apparatus, an operation processing method, and a computer program.

### BACKGROUND TECHNOLOGY

Controllers equipped with analog sticks are widely used as controllers for users to input operations into application software such as games.

### SUMMARY OF INVENTION

### PROBLEM TO BE SOLVED BY INVENTION

Recently, systems have been developed that treat a plurality of analog sticks as a single input device. In the systems, when the sum of the operation amounts for each of the plurality of analog sticks is used as the input value to the system, this may result in an input value unintended by the user, potentially resulting in an operation result unintended by the user. A main object of the present invention is to provide a technique for suppressing an operation result that is not intended by the user when a plurality of operation members are treated as a single input device.

### MEANS TO SOLVE THE PROBLEM

In order to achieve the object, an operation processing apparatus according to one aspect of the present invention includes: an acquisition unit that acquires values related to operation amounts of a plurality of operation members detected as information on a two-dimensional plane by a user’s input operation; a determination unit that determines, when a value related to an operation amount of each of the plurality of operation members is within a range that is considered to be in a stationary state, a representative operation member from among the plurality of operation members based on a predetermined rule; and a generation unit that generates operation information based on a value related to an operation amount for the representative operation member.

Another aspect of the present invention is an operation processing method. This method executed by a computer includes: acquiring values related to operation amounts of a plurality of operation members detected as information on a two-dimensional plane by a user’s input operation; determining, when a value related to an operation amount of each of the plurality of operation members is within a range that is considered to be in a stationary state, a representative operation member from among the plurality of operation members based on a predetermined rule; and generating operation information based on a value related to an operation amount for the representative operation member.

Any combination of the components, or conversions of the present invention between an operation apparatus, an information processing apparatus, a system, a computer program, or a recording medium storing a computer program, or the like are also effective aspects of the present invention.

### EFFECT OF THE INVENTION

According to the present invention, when the plurality of operation members are treated as a single input device, it is possible to suppress an operation result that is not intended by the user.

### BRIEF DESCRIPTION OF THE DRAWINGS

FIG. 1 is a diagram illustrating a configuration of an information processing system according to a first embodiment.

FIG. 2 is a diagram illustrating a hardware configuration related to a first embodiment of a controller.

FIG. 3 is a diagram illustrating a relationship between operation of an analog stick and an input value.

FIG. 4 is a block diagram illustrating the functional blocks of the controller of the first embodiment.

FIG. 5 is a flowchart illustrating the operation of the controller of the first embodiment.

FIG. 6 is a flowchart illustrating the operation of the controller following FIG. 5.

FIG. 7 is a block diagram illustrating the functional blocks of a controller of a second embodiment.

FIG. 8 is a flowchart illustrating the operation of the controller of the second embodiment.

FIG. 9 is a diagram explaining damping calculation of the second embodiment.

FIG. 10 is a diagram explaining the damping calculation of a modification.

### DESCRIPTION OF THE EMBODIMENTS

### <First Embodiment>

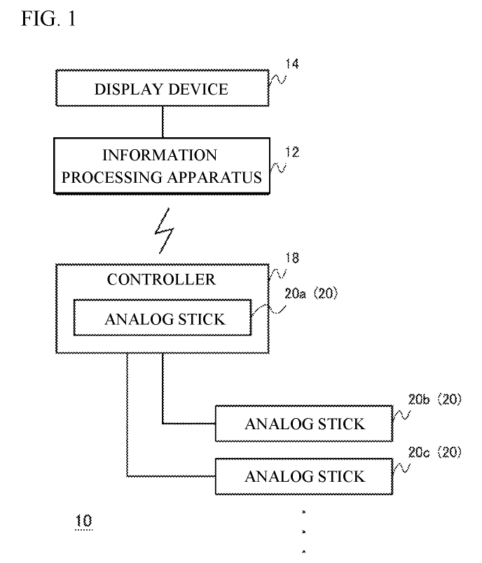

FIG. 1 illustrates the configuration of an information processing system 10 according to a first embodiment. The information processing system 10 includes an information processing apparatus 12, a display device 14, a controller 18, an analog stick 20a, an analog stick 20b, and an analog stick 20c.

The information processing apparatus 12 is a computer capable of executing various software, such as system software and application software, and is a stationary game console in the first embodiment. Alternatively, the information processing apparatus 12 may be a PC, tablet terminal, smartphone, or server.

The controller 18 is a device that accepts operations input by the user to the system software or application software (that is, a video game) executed by the information processing apparatus 12. The controller 18 may also be considered an operation apparatus. The controller 18 includes the functionality of an operation processing apparatus that executes data processing related to the generation of operation information indicating operations input by the user. The controller 18 sequentially transmits the generated operation information to the information processing apparatus 12. The controller 18 is connected to the information processing apparatus 12 via a wired or wireless connection. The controller 18 may also be an adaptive controller that is intended to be used by users with various conditions, such as people with physical disabilities.

The analog stick 20a is an analog stick device that is provided at a predetermined position of the controller 18 when manufacturing the controller 18. Meanwhile, the analog stick 20b and analog stick 20c are analog stick devices externally attached to the controller 18. For example, the analog stick 20b and analog stick 20c may be connected to an AUX port of the controller 18 via a wired connection, or may be connected to the controller 18 wirelessly.

The analog stick 20a, analog stick 20b, and analog stick 20c (collectively referred to as an “analog stick 20”) are pre-configured to be treated as a single analog stick. The user uses the analog stick 20a, analog stick 20b, and analog stick 20c in parallel to input the operations for system software and application software executed on the information processing apparatus 12.

The analog stick 20 is also called a control stick, thumb stick, or joystick, and is used to input the direction and amount of tilt. The amount of tilt may also be considered the angle at which the analog stick 20 is tilted. The analog stick 20 may also function as a push-button that sinks downward when pressed by the user and returns to the original position when the user releases the button.

The display device 14 has a display for outputting an image and a speaker for outputting sound. The display device 14 may be a television or a computer display. The display device 14 is connected to the information processing apparatus 12 via a wired or wireless connection. Upon receiving the operation information transmitted from the controller 18, the information processing apparatus 12 reflects the operation information in the processing of system software and application software, displays an image related to the processing results on the display device 14, and outputs sound related to the processing results from the speaker of the display device 14.

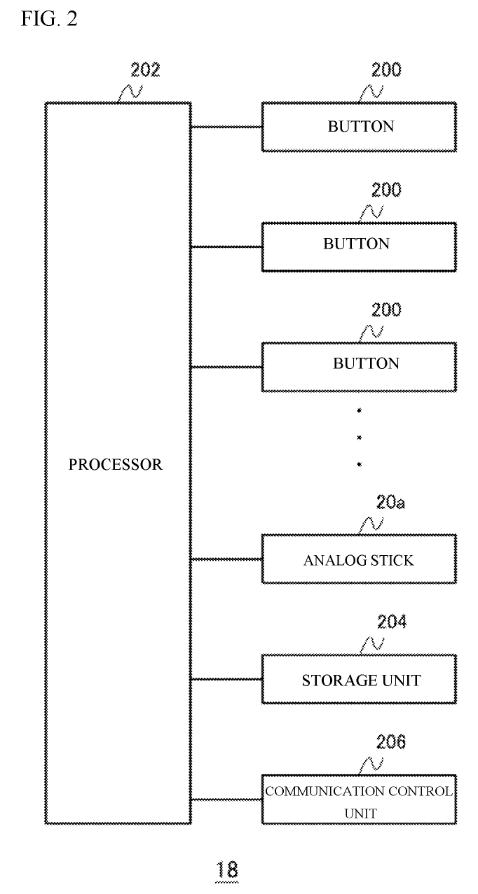

FIG. 2 illustrates the hardware configuration related to a first embodiment of the controller 18. The controller 18 includes a plurality of buttons 200, an analog stick 20a, a processor 202, a storage unit 204, a communication control unit 206, and an AUX port 208.

Various functions that allow the user to control the system software and application software executed on the information processing apparatus 12 are assigned to the plurality of buttons 200. The functions assigned to the plurality of buttons 200 may include a confirmation function, a cancel function, an option function, and a directional key function for directional input.

The processor 202 executes various data processing and controls the operation of various hardware. The processor 202 may include a Central Processing Unit (CPU), a memory, and a System on a Chip (SoC). The storage unit 204 stores data referenced or updated by the processor 202.

The communication control unit 206 controls communication with an external device. In the first embodiment, the communication control unit 206 communicates wirelessly with the information processing apparatus 12. However, in a modification, wired communication with the information processing apparatus 12 may also be used. The AUX plugs of the analog stick 20b and analog stick 20c are connected to the AUX port 208.

A user’s input operation on the analog stick 20 is detected as information (hereinafter referred to as “operation amount” or “input value”) on a two-dimensional plane consisting of the X-axis and Y-axis. The controller 18 outputs the operation information related to the detected operation amount to the information processing apparatus 12.

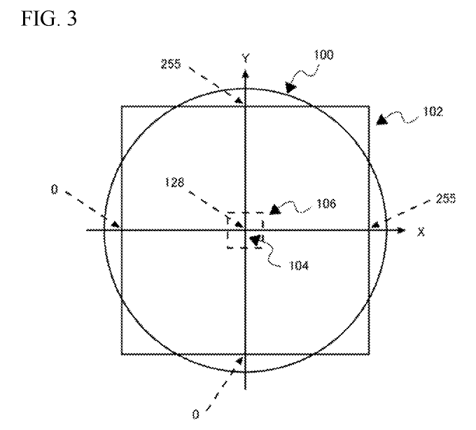

FIG. 3 illustrates the relationship between the operation of the analog stick 20 and the input value. A stick movable range 100, indicated by a circle in FIG. 3, indicates the range over which the analog stick 20 can actually be moved. A solid-line rectangle in FIG. 3 indicates a data normalization range 102. The data normalization range 102 is a range to which an input value corresponding to the operation amount is assigned. This operation amount may also be considered an analog value (voltage value) read in response to a tilt operation of the analog stick 20. A dashed arrow in FIG. 3 indicates the input value assigned in the data normalization range 102. In the data normalization range 102, input values between 0 and 255 are assigned in both the X-axis and Y-axis directions. A return position 104 may also be called the center return position, and is the position of the analog stick 20 when a finger is off the analog stick 20 (that is, when not operating).

The input value at the return position 104 is 128 in both the X-axis and Y-axis directions.

The dashed rectangle in FIG. 3 indicates a device neutral range 106. The device neutral range 106 is the range in which the analog stick 20 is considered to be in a stationary state (that is, unoperated). In the first embodiment, the device neutral range 106 is a range of values in the X-axis direction of 128±13 and in the Y-axis direction of 128±13. For example, when the operation amount indicated by the operation information received from the controller 18 is the value within the device neutral range 106, the system software or application software executed on the information processing apparatus 12 determines that the analog stick 20 is in a stationary state (that is, unoperated) and executes processing appropriate for the analog stick 20 being in the stationary state.

Here, drift that may occur when the plurality of analog sticks 20 are in the stationary state will be described. In recent years, a technology has been proposed that considers operations on the plurality of analog sticks 20 as operations on a single analog stick 20 to obtain input values for the system. In this method, when the sum of the detected operation amounts for the plurality of analog sticks 20 is used as the input value to the system, the operation amount for each analog stick 20 may be within the device neutral range 106, but when the value close to the boundary of the device neutral range 106 is detected, the sum of the operation amounts may deviate from the device neutral range 106. As a result, there is a possibility that the analog stick 20 may be mistakenly determined to be operated when it should actually be determined that the analog stick 20 is not being operated.

Therefore, when the operation amount of each of the plurality of analog sticks 20 is the value within the device neutral range 106, the controller 18 of the first embodiment determines one representative analog stick 20 from among the plurality of analog sticks 20 based on a predetermined rule. Specifically, the controller 18 of the first embodiment identifies the analog stick 20 stopped last among the plurality of analog sticks 20 and determines the analog stick 20 as the representative analog stick 20. The controller 18 generates the operation information based on the value related to the operation amount for the representative analog stick 20. Accordingly, it is possible to reduce the likelihood of the above-mentioned erroneous determination occurring.

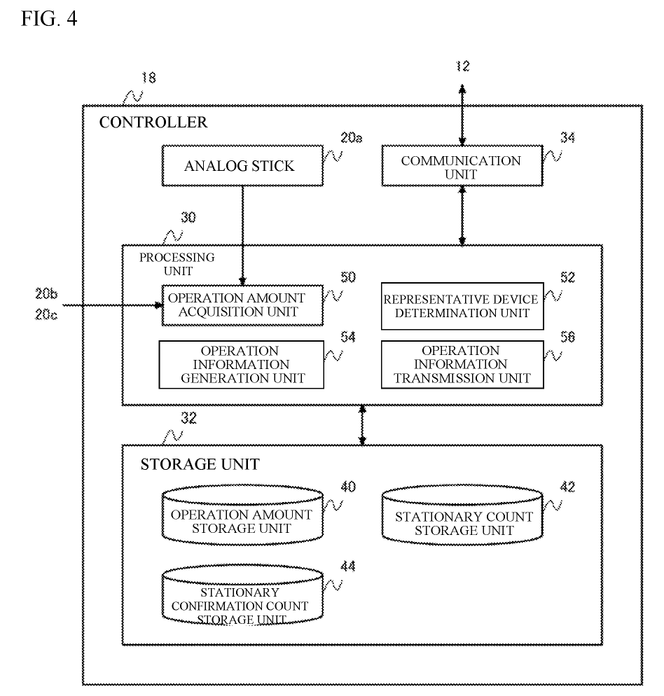

FIG. 4 is a block diagram illustrating the functional blocks of the controller 18 of the first embodiment. Each block illustrated in the block diagrams in the present specification can be realized in hardware terms by elements such as a computer processor, CPU, and memory, as well as electronic circuits and mechanical devices, and in software terms by a computer program loaded into memory, or the like, but here functional blocks realized by the cooperation of these elements are illustrated. Therefore, those skilled in the art will understand that these functional blocks can be realized in various ways using a combination of hardware and software.

The controller 18 includes the analog stick 20a, a processing unit 30, a storage unit 32, and a communication unit 34. The processing unit 30 performs various data processing. The processing unit 30 corresponds to the processor 202 in FIG. 2. The storage unit 32 stores data referenced or updated by the processing unit 30. The storage unit 32 corresponds to the storage unit 204 in FIG. 2. The communication unit 34 corresponds to the communication control unit 206 in FIG. 2 and communicates with external devices according to a predetermined communication protocol. The processing unit 30 transmits and receives data to and from the information processing apparatus 12 via the communication unit 34.

The storage unit 32 includes an operation amount storage unit 40, a stationary count storage unit 42, and a stationary confirmation count storage unit 44. The operation amount storage unit 40 stores operation amounts, which are information indicating the magnitude of operations input to each of the analog sticks 20a, 20b, and 20c. In the embodiment, the operation amounts are values between 0 and 255 for a plurality of combinations of the type of the analog stick 20 and axial direction (X-axis and Y-axis). For example, the operation amount storage unit 40 stores the X-axis and Y-axis operation amounts of analog stick 20a, the X-axis and Y-axis operation amounts of analog stick 20b, and the X-axis and Y-axis operation amounts of analog stick 20c.

The stationary count storage unit 42 stores stationary counts. The stationary count indicates the number of times the analog stick 20 is determined to be stationary, and in the embodiment, a value between 0 and 100 is stored. In the embodiment, a stationary count is provided for each analog stick 20 and for each X-axis and Y-axis. For example, the stationary count storage unit 42 stores the X-axis stationary count and Y-axis stationary count for the analog stick 20a, the X-axis stationary count and Y-axis stationary count for the analog stick 20b, and the X-axis stationary count and Y-axis stationary count for the analog stick 20c.

The stationary confirmation count storage unit 44 stores the X-axis stationary confirmation count and the Y-axis stationary confirmation count. The stationary confirmation count indicates the number of analog sticks 20 that have been determined to be stationary. For example, when the information processing system 10 includes the analog sticks 20a, 20b, and 20c, a value between 0 and 3 is stored for each of the X-axis stationary confirmation count and the Y-axis stationary confirmation count.

The processing unit 30 includes an operation amount acquisition unit 50, a representative device determination unit 52, an operation information generation unit 54, and an operation information transmission unit 56. A computer program (for example, firmware) implementing the plurality of functions may be stored in the storage unit 204 of the controller 18. The processor 202 of the controller 18 may perform the plurality of functions by loading this computer program into main memory and executing the computer program.

The operation amount acquisition unit 50 acquires values related to the operation amounts of the plurality of analog sticks 20, which detect the user’s input operation as information on a two-dimensional plane. In the embodiment, the operation amount acquisition unit 50 repeatedly acquires the value of the operation amount input to each of the analog sticks 20a, 20b, and 20c at a predetermined cycle (1 millisecond in the embodiment). The value of the operation amount in the embodiment is the value within the data normalization range 102 illustrated in FIG. 3. That is, the value of the operation amount includes the value in the X-axis direction (0 to 255) and the value in the Y-axis direction (0 to 255) on the two-dimensional plane.

When the value related to the operation amount of each of the plurality of analog sticks 20 is within the range (that is, the device neutral range 106 in FIG. 3) considered to be in the stationary state, the representative device determination unit 52 determines the representative analog stick 20 from among the plurality of analog sticks 20 based on predetermined rules. In the first embodiment, the representative device determination unit 52 determines the analog stick 20 stopped last among the plurality of analog sticks 20 as the representative analog stick 20, based on the values related to the operation amounts of the plurality of analog sticks 20 repeatedly acquired by the operation amount acquisition unit 50.

When the value related to the operation amount of each of the plurality of analog sticks 20 is within the range (the device neutral range 106) considered to be in the stationary state, the operation information generation unit 54 generates the operation information based on the value related to the operation amount for the representative analog stick 20 determined by the representative device determination unit 52. This operation information may include the value of 128±13 as the value of the operation amount.

When the last-stopped analog stick 20 has not been determined, the representative device determination unit 52 does not determine the representative analog stick 20. For example, when the value of the operation amount of at least one of the plurality of analog sticks 20 is a value outside the device neutral range 106, the representative device determination unit 52 does not determine the representative analog stick 20. When the representative analog stick 20 has not been determined, in other words, when the last-stopped analog stick 20 has not been determined, the operation information generation unit 54 generates the operation information based on the sum of the values related to the operation amounts of the plurality of analog sticks 20.

The operation information transmission unit 56 transmits the operation information generated by the operation information generation unit 54 to the information processing apparatus 12 via the communication unit 34.

The operation of the information processing system 10 configured as described above will now be described.

The operation amount acquisition unit 50 of the controller 18 acquires the operation amounts of each of the analog sticks 20a, 20b, and 20c. The operation information generation unit 54 of the controller 18 generates a single piece of operation information based on the operation amounts of each of the analog sticks 20a, 20b, and 20c. The operation information transmission unit 56 of the controller 18 transmits the operation information generated by the operation information generation unit 54 to the information processing apparatus 12. The operation amount acquisition unit 50 repeatedly executes this series of operations at a predetermined cycle.

When the operation amounts of all analog sticks 20 are within the device neutral range 106 and the analog stick 20 operated last (hereinafter, also referred to as a “finally operated stick”) can be determined, the operation information generation unit 54 generates operation information indicating the operation amount of the finally operated stick as the representative analog stick 20. The operation amount here is a normalized value between 0 and 255 for each of the X-axis and Y-axis directions.

Meanwhile, when the operation amount of at least one analog stick 20 falls outside the device neutral range 106 or the finally operated stick cannot be determined, the operation information generation unit 54 generates input values in the X-axis direction and Y-axis direction by summing the operation amounts for each of the analog sticks 20a, 20b, and 20c, and generates operation information indicating these input values. This process is also called “simple addition”.

The information processing apparatus 12 receives the operation information transmitted from the controller 18. The information processing apparatus 12 executes the system software and application software based on the operation amount of the analog stick 20 indicated by the received operation information, and displays the execution results on the display device 14.

Next, the process leading up to the generation of operation information in the controller 18 will be described in detail.

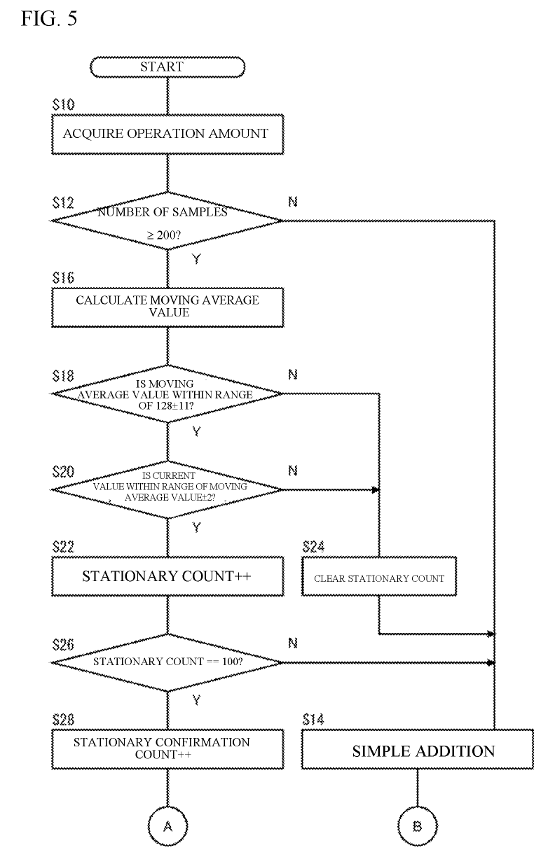

FIG. 5 is a flowchart illustrating the operation of the controller 18 in the first embodiment.

Each time operation amount data (input values in the X-axis direction and Y-axis direction) for the plurality of analog sticks 20 is acquired, the series of processes illustrated in FIG. 5 is repeatedly executed.

The operation amount acquisition unit 50 acquires the operation amount data for each of the analog sticks 20a, 20b, and 20c at a predetermined cycle (every 1 millisecond in the first embodiment) and obtains the normalized value (0 to 255) of the operation amount for each analog stick 20 (S10). The operation amount acquisition unit 50 stores the normalized value of the operation amount for each analog stick 20 in the operation amount storage unit 40.

When the number of operation amount data for each analog stick 20 acquired by the operation amount acquisition unit 50 and stored in the operation amount storage unit 40 is less than 200 (N in S12), the representative device determination unit 52 skips the process of determining the last operated analog stick 20. The operation information generation unit 54 generates the operation information by simply adding the operation amounts of each of the analog sticks 20a, 20b, and 20c (S14).

When the number of operation amount data for each analog stick 20 acquired by the operation amount acquisition unit 50 reaches 200 (Y in S12), the representative device determination unit 52 executes the following process for each analog stick 20 and for each X-axis direction and Y-axis direction. Hereinafter, the combination of a specific analog stick 20 and the X-axis direction or Y-axis direction will be referred to as a “determination target”. S16 through S28 are executed for each determination target.

The representative device determination unit 52 calculates a moving average value based on the latest 200 operation amounts related to the determination target stored in the operation amount storage unit 40 (S16). Note that when new operation amount data is acquired, the oldest operation amount data is deleted from the operation amount storage unit 40. When the moving average value is within the range of 128±11 (Y in S18) and the latest operation amount is within the range of the moving average value±2 (Y in S20), the representative device determination unit 52 increments the stationary count (initial value 0, maximum value 100) of the target device stored in the stationary count storage unit 42 (S22). Note that Y in S20 occurs when the latest operation amount is the value within the device neutral range 106 (that is, 128±13).

When the moving average value falls outside the range of 128±11 (N in S18) or when the latest operation amount falls outside the range of the moving average value±2 (N in S20), the representative device determination unit 52 resets the stationary count of the determination target stored in the stationary count storage unit 42 to 0 (S24). Then, the process proceeds to the simple addition (S14). The determination in S20 can eliminate the effects of electrical chattering. Note that the threshold (that is, ±11) in S18 and the threshold (that is, ±2) in S20 may be set to appropriate values based on the developer’s knowledge or experiments using the information processing system 10. In S24, the stationary count is reset to 0, and all stationary confirmation counts stored in the stationary confirmation count storage unit 44 may also be reset to 0.

After incrementing the stationary count of the determination target, when the stationary count reaches 100 (Y in S26), the representative device determination unit 52 increments the stationary confirmation count (that is, the stationary confirmation count in the X-axis direction or the stationary confirmation count in the Y-axis direction) in the axis direction to which the determination target belongs, which is stored in the stationary confirmation count storage unit 44 (S28). When the stationary count of the determination target is less than 100 (N in S26), the process proceeds to simple addition (S14).

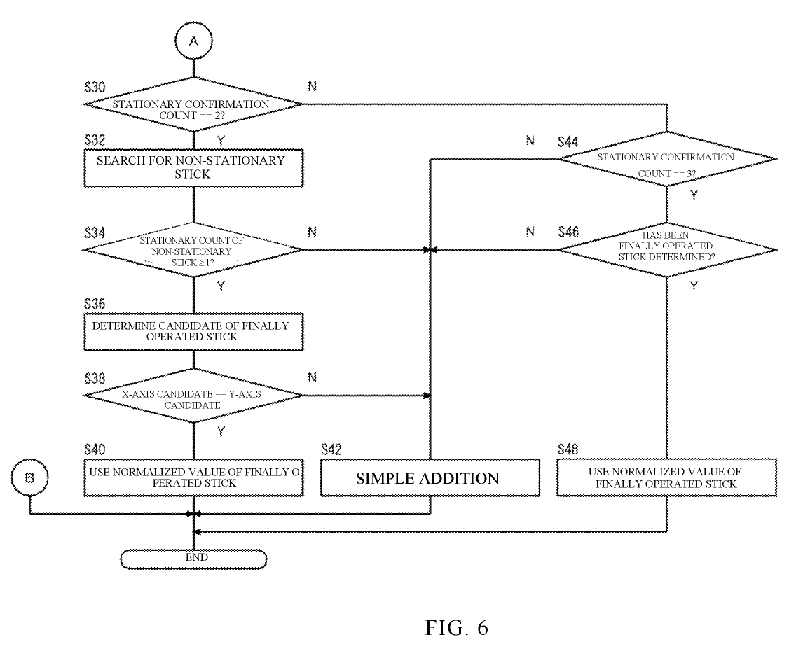

FIG. 6 is a flowchart illustrating the operation of the controller 18 following FIG. 5. The representative device determination unit 52 executes the series of processes illustrated in FIG. 6 for each of the X-axis and Y-axis directions.

When the stationary confirmation count reaches (the number of analog sticks 20 - 1), that is, in the configuration, the stationary confirmation count is 2 (Y in S30), the representative device determination unit 52 searches for the analog stick 20 (herein also referred to as a “non-stationary stick”) whose stationary count is less than 100 (S32). When the value of the stationary count (in the X-axis or Y-axis direction) of the non-stationary stick stored in the stationary count storage unit 42 is 1 or greater (Y in S34), the representative device determination unit 52 determines the non-stationary stick as a candidate for the finally operated stick in the axis direction (S36).

When the candidate for the finally operated stick in the X-axis direction and the candidate for the finally operated stick in the Y-axis direction match (Y in S38), the representative device determination unit 52 determines the candidate as the finally operated stick, in other words, as the representative analog stick 20. The operation information generation unit 54 generates the operation information indicating the value (here, normalized value in the range of 128±13) of the operation amount for the finally operated stick (S40).

When the value of the stationary count (X-axis or Y-axis direction) of the non-stationary stick is 0 (N in S34), or when the candidate for the finally operated stick in the X-axis direction and the candidate for the finally operated stick in the Y-axis direction do not match (N in S38), the operation information generation unit 54 generates the operation information by simply adding the operation amounts of the analog sticks 20a, 20b, and 20c (S42).

When the stationary confirmation count is not 2 (N in S30) but is 3 (Y in S44), the operation information generation unit 54 determines whether the representative device determination unit 52 has determined the finally operated stick. In the first embodiment, since the three analog sticks of the analog stick 20, the analog stick 20a, the analog stick 20b, and analog stick 20c are treated as the single analog stick 20, the stationary confirmation count of 3 indicates that all analog sticks 20 have been determined to be stationary in the X-axis or Y-axis direction. For example, when five analog sticks 20 are treated as a single analog stick 20, the determination value in S30 will be 4 and the determination value in S44 will be 5.

When the finally operated stick has been determined (Y in S46), the operation information generation unit 54 generates the operation information indicating the value (here, normalized value in the range of 128±13) of the operation amount for the finally operated stick (S48). When the stationary confirmation count is not 3, that is, when the stationary confirmation count is 0 or 1 (N at S44), or when the finally operated stick has not been determined (N at S46), the operation information generation unit 54 generates the operation information by simply adding the operation amounts of the analog sticks 20a, 20b, and 20c (S42).

Below, a plurality of cases related to the operations of the plurality of analog sticks 20 are explained.

Case 1: When plurality of analog sticks 20 are simultaneously determined to be stationary

The flow goes from N at S46 to S42. That is, since it is not possible to determine the single finally operated stick, the operation amounts of the plurality of analog sticks 20 are simply added.

Case 2: After finally operated stick is determined, finally operated stick is operated outside device neutral range 106

After the finally operated stick is determined, the flow goes to N at S20 and S24 in the process of FIG. 5. That is, the process returns to the process of simply adding the operation amounts of the plurality of analog sticks 20

Case 3: After finally operated stick is determined, when finally operated stick is operated within the device neutral range 106

(1) When the operation is within the moving average value±2, the operation amount of the determined finally operated stick alone is output.

(2) When the operation is outside the moving average value±2, the flow goes to N at S20 and S24, returning to the simple addition. However, when another analog stick 20 is not being operated, the same analog stick 20 is immediately determined to be the finally operated stick. Moreover, since the comparison is made with the moving average value, when the user slowly operates the finally operated stick within the device neutral range 106, the determination of the finally operated stick is maintained.

Case 4: After finally operated stick is determined, another analog stick 20 is operated within device neutral range 106.

(3) When the operation is within the range of the moving average value±2, the operation amount of the determined finally operated stick alone is output, just as before the operation of the other analog stick 20.

(4) When the operation is outside the range of the moving average value±2, the flow goes to N in S20 and S24, where the process returns to the simple addition and the stationary determination is redone. When the stationary determination is redone, the other analog stick 20 becomes the finally operated stick.

According to the controller 18 of the first embodiment, when the plurality of analog sticks 20 are treated as a single input device, it is possible to suppress the operation result that is not intended by the user. For example, it is possible to suppress the situation where the plurality of analog sticks 20 are mistakenly recognized as being operated when none of them are being operated.

Furthermore, the user often continues to use the analog stick 20 the user has operated last (or, in other words, the analog stick 20 the user has operated most recently). According to the controller 18 of the first embodiment, when the operation amounts of all analog sticks 20 are within the device neutral range 106, the operation information is generated based on the operation amount of the analog stick 20 that the user is most likely to operate next. This makes it less likely that the user will feel uncomfortable with the processing results of the information processing apparatus 12 based on the operation information.

Furthermore, according to the controller 18 of the first embodiment, when the analog stick 20 stopped last is not determined, the operation information is generated based on the total result of the operation amounts of the plurality of analog sticks 20. This makes it less likely that the user will feel uncomfortable with the processing results of the information processing apparatus 12 based on that operation information.

The above describes the present invention based on the first embodiment. The first embodiment is merely an example, and it will be understood by those skilled in the art that various modifications are possible in the combination of each component and each processing process, and that such modifications are also within the scope of the present invention.

Modifications to the first embodiment will be described. In the first embodiment, in the process of S38 in FIG. 6, when the candidate for the finally operated stick in the X-axis direction and the candidate for the finally operated stick in the Y-axis direction match, the representative device determination unit 52 determines the candidate as the representative analog stick 20. As a modification, the controller 18 may be configured to allow the user to switch between enabling and disabling the process of S38.

Specifically, the process of S38 may be enabled when the plurality of analog sticks 20 are to operate as the single analog stick 20. This is useful when there are a main operator and an auxiliary operator and operations by either operator are to be accepted. Furthermore, when each of the plurality of analog sticks 20 is to be used for operation in only one axis direction, for example, when the analog stick 20a is used for operation in the X-axis direction, the analog stick 20b is used for operation in the Y-axis direction, or the like, the process of S38 may be disabled. When the process of S38 is disabled, an analog stick 20 may be determined as the representative analog stick 20 in the X-axis direction, and another analog stick 20 may be determined as the representative analog stick 20 in the Y-axis direction.

### <Second Embodiment>

This section will focus on the differences between a second embodiment and the first embodiment, and will omit a description of the commonalities. Of course, the features of the second embodiment may be combined with the features of the first embodiment and the modifications thereof. Below, elements of the second embodiment that are identical to or correspond to elements of the first embodiment will be designated by the same reference numerals.

The configuration of the information processing system 10 of the second embodiment is similar to the configuration of the information processing system 10 of the first embodiment illustrated in FIG. 1. In the second embodiment, the analog stick 20a, analog stick 20b, and analog stick 20c are treated as a single input device.

Similar to the controller 18 of the first embodiment, the controller 18 of the second embodiment determines the one representative analog stick 20 from among the plurality of analog sticks 20 based on the predetermined rule when the operation amount of each of the plurality of analog sticks 20 is the value within the device neutral range 106. Specifically, the controller 18 of the second embodiment determines the analog stick 20 having the largest most recent displacement amount among the plurality of analog sticks 20 as the representative analog stick 20. The controller 18 generates the operation information based on the value related to the operation amount for the representative analog stick 20. This reduces the possibility that it will be determined that all of the analog sticks 20 are not being operated when they are not.

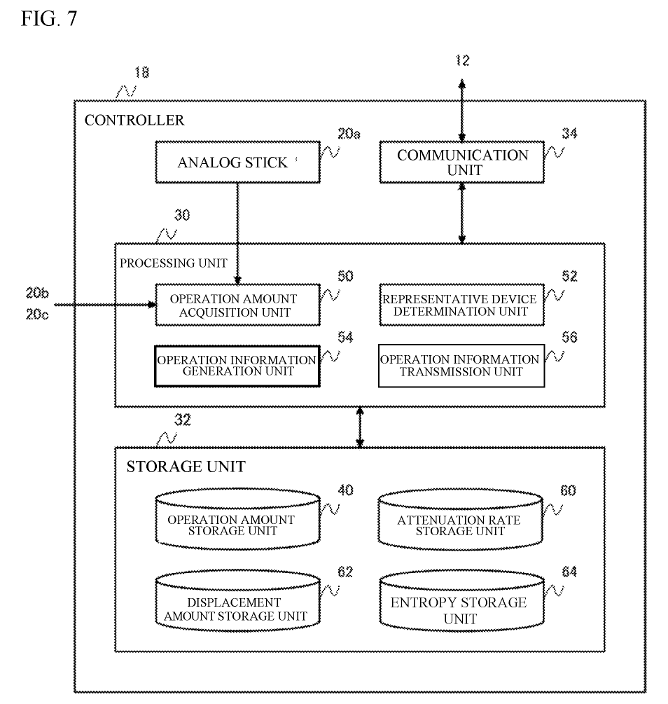

FIG. 7 is a block diagram illustrating the functional blocks of the controller 18 of the second embodiment. The controller 18 of the second embodiment differs from the controller 18 of the first embodiment in the configuration of the storage unit 32. The storage unit 32 includes the operation amount storage unit 40, an attenuation rate storage unit 60, a displacement amount storage unit 62, and an entropy storage unit 64.

The displacement amount storage unit 62 stores, for each analog stick 20 and each axial direction, a difference (hereinafter, also referred to as a “displacement amount”) between the value of operation amount at time t+1 and the value of the operation amount at time t. The time t+1 is a time point when one unit time has elapsed since time t. The unit time may be the cycle for acquiring the operation amount of the analog stick 20, and may be, for example, 1 millisecond. The displacement amount storage unit 62 stores time-series data (hereinafter, also referred to as a “displacement amount array”) of the displacement amount for each analog stick 20 and each axial direction.

The attenuation rate storage unit 60 stores a plurality of attenuation rates corresponding to a predetermined elapsed time and multiplied by the plurality of displacement amounts in the displacement amount array. Each attenuation rate is determined so that the older the displacement amount, the smaller the effect. For example, when the attenuation rate multiplied by the most recent displacement amount is 1 and the attenuation rate multiplied by the oldest displacement amount is 0.1, the attenuation rates between them will be greater than 0.1 and less than 1, with the attenuation rates corresponding to earlier points in time becoming smaller. The attenuation rate storage unit 60 stores attenuation rate data (hereinafter, also referred to as an “attenuation rate array”) for each elapsed time. Note that the values of the plurality of attenuation rates may be determined to appropriate values based on the developer’s knowledge or experiments using the information processing system 10.

The entropy storage unit 64 stores an entropy array indicating the result of multiplying the displacement amount recorded in the displacement amount array by the attenuation rate recorded in the attenuation rate array. The entropy is the value obtained by multiplying the displacement amount at a certain time point by the attenuation rate corresponding to the time point, and may also be considered a weighted displacement amount that decreases as the elapsed time increases. The entropy may also be considered the amount of information related to the operation of the analog stick 20.

The representative device determination unit 52 determines, as the representative analog stick 20, the analog stick 20 having the largest displacement amount (in other words, the sum of entropy) within a predetermined time among the plurality of analog sticks 20 based on the values related to the operation amount repeatedly acquired by the operation amount acquisition unit 50. Specifically, the representative device determination unit 52 derives the displacement amounts at a plurality of time points within the predetermined time for each analog stick 20 and stores the displacement amounts in the displacement amount storage unit 62. The representative device determination unit 52 derives the displacement amount (in other words, the sum of entropy) within the predetermined time for each analog stick 20 by summing the displacement amounts (in other words, the entropy) at the plurality of time points described above according to the attenuation rate for each time point within the predetermined time stored in the attenuation rate storage unit 60, so that the influence of earlier displacement amounts is smaller.

As in the first embodiment, the operation information generation unit 54 generates the operation information based on the operation amount for the representative analog stick 20 determined by the representative device determination unit 52.

The operation of the information processing system 10 in the second embodiment is basically the same as that of the information processing system 10 in the first embodiment, except for the operation up to the determination of the representative analog stick 20 in the controller 18.

The operation up to the determination of the representative analog stick 20 in the controller 18 is described below.

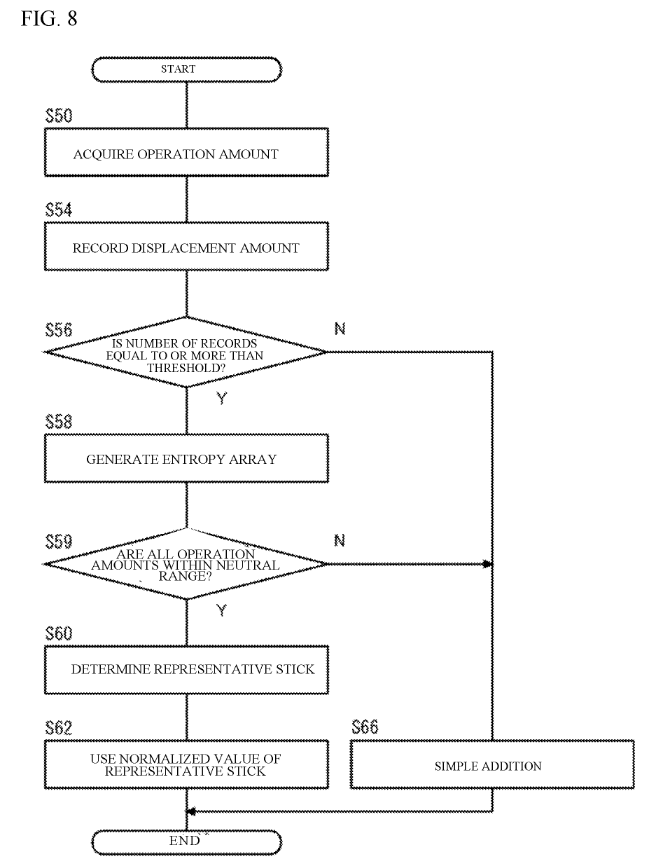

FIG. 8 is a flowchart illustrating the operation of the controller 18 in the second embodiment. Each time operation amount data (input values in the X-axis and Y-axis directions) for the plurality of analog sticks 20 is obtained, the series of processes illustrated in FIG. 8 is repeatedly executed.

The operation amount acquisition unit 50 acquires the operation amount data for each of the analog sticks 20a, 20b, and 20c at a predetermined cycle (1 millisecond in the first embodiment) (S50). The operation amount acquisition unit 50 stores data of the operation amount (hereinafter, referred to as an “individual operation amount”) for each analog stick 20 and each axial direction in the operation amount storage unit 40.

The representative device determination unit 52 stores data on the plurality of displacement amounts (that is, difference from individual operation amounts one unit time ago) related to the plurality of individual operation amounts in the displacement amount array of the displacement amount storage unit 62 (S54).

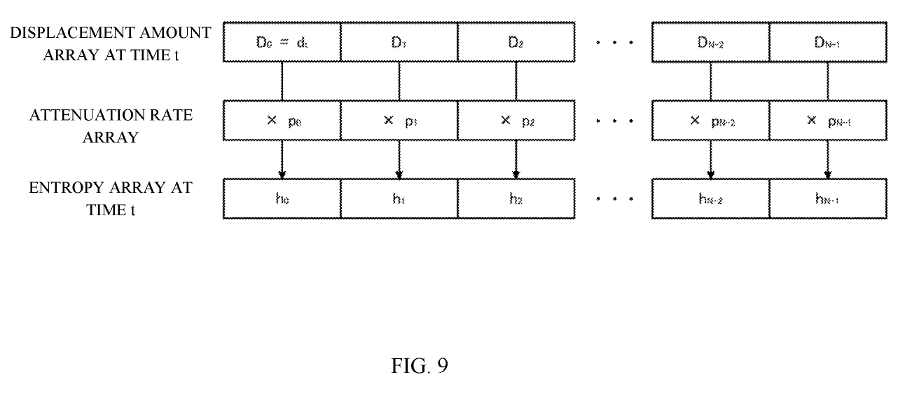

FIG. 9 is a diagram illustrating the damping calculation of the second embodiment. The displacement amount array of the embodiment stores N displacement amounts (D₀ to D_{N-1}). The size of the displacement amount array, that is, the number N of displacement amounts to be stored, may be set to an appropriate value based on the developer’s knowledge or experiments using the information processing system 10. D₀ indicates the difference between the operation amount at the most recent time point (time t) and the operation amount one unit time ago. D₁ indicates the difference between the operation amount one unit time before time t and the operation amount two-unit time before time t. D_{N}₋₁ indicates the difference between the operation amount (N-2) x unit time before time t and the operation amount (N-1) x unit time before time t. When a new displacement amount is calculated, the oldest displacement amount at the time point is deleted from the displacement amount array, and the new displacement amount is stored in the displacement amount array.

As illustrated in FIG. 9, the attenuation rate array stores the plurality of attenuation rates (p₀ to p_{N}₋₁) corresponding to the plurality of time slots in the displacement amount array. In the embodiment, the values of the plurality of attenuation rates are determined so that the entropy, which is the result of multiplication by the displacement amount, becomes smaller for attenuation rates corresponding to earlier time slots. For example, the magnitude relationship between the plurality of attenuation rates illustrated in FIG. 9 is determined as p₀>p₁>p₂> ... >p_{N-2}>p_{N-1}.

When the number of displacement amount data recorded in the displacement amount array is equal to or more than a predetermined threshold (N in the embodiment) (Y in S56), the representative device determination unit 52 generates the entropy array for each individual operation amount and stores the entropy array in the entropy storage unit 64 (S58). Specifically, the representative device determination unit 52 multiplies the displacement amount for one time slot in the displacement amount array by the attenuation rate for the time slot in the attenuation rate array, and derives the result as the entropy for the time slot. The entropy array in FIG. 9 includes N entropies (h₀, h₁, h₂, h_{N-2}, h_{N-1}, in order of most recent).

The representative device determination unit 52 determines whether all of the operation amounts for each analog stick 20 and each axial direction obtained in S50 are within the device neutral range 106. When all operation amounts are within the device neutral range 106 (Y in S59), the representative device determination unit 52 sums the entropy values of each time slot in the entropy array for each individual operation amount (that is, for each combination of the analog stick 20 and axial direction). The representative device determination unit 52 determines the analog stick 20 having the largest total entropy value for each of the X-axis and Y-axis directions as the representative analog stick 20 (S60). The operation information generation unit 54 generates operation information indicating the value of the operation amounts for the representative analog stick 20 (S62). For example, the operation information generation unit 54 generates operation information in which the operation amount for the representative analog stick 20 in the X-axis direction is set as the operation amount for the X-axis direction, and the operation amount for the representative analog stick 20 in the Y-axis direction is set as the operation amount for the Y-axis direction.

When the number of displacement amount data recorded in the displacement amount array is less than the threshold N (N in S56), the operation information generation unit 54 generates the operation information by simply adding the operation amounts of the analog sticks 20a, 20b, and 20c (S66). Furthermore, when the operation amount (that is, at least one individual operation amount) for at least one of the plurality of combinations of the analog sticks 20 and axial directions falls outside the device neutral range 106 (N in S59), the operation proceeds to the simple addition in S66.

Similar to the controller 18 of the first embodiment, when the plurality of analog sticks 20 are treated as a single input device, to the controller 18 of the second embodiment can suppress the operation result that is not intended by the user.

Furthermore, with the controller 18 of the second embodiment, when the operation amount of each analog stick 20 is within the device neutral range 106, it is possible to identify the analog stick 20 that is most likely to have been operated within the device neutral range 106, and to generate the operation information based on the operation amount of the analog stick 20 that the user is most likely to operate next. This makes it less likely that the user will feel uncomfortable with the processing results of the information processing apparatus 12 based on that operation information.

Furthermore, the controller 18 of the second embodiment determines the representative analog stick 20 for each of the X-axis and Y-axis directions. This makes it possible to set appropriate input values for the operation information even when operation in the X-axis and the operation in Y-axis directions is performed using separate analog sticks 20.

The present invention has been described above based on the second embodiment. The second embodiment is merely an example, and it will be understood by those skilled in the art that various modifications are possible in the combination of each component and each processing process, and that such modifications are also within the scope of the present invention.

A modification will now be described. This modification relates to the second embodiment. In the second embodiment, the representative device determination unit 52 multiplies the displacement amount Dₙ for each elapsed time by the attenuation rate pₙ (that is, the attenuation rate for each elapsed time) corresponding to the elapsed time to derive the entropy value hₙ for each elapsed time. As a modification, the representative device determination unit 52 may multiply the displacement amount for each elapsed time by the same attenuation rate p every time a unit time elapses.

The storage unit 32 of the controller 18 in this modification includes the operation amount storage unit 40 and the entropy storage unit 64, but does not include the attenuation rate storage unit 60 or the displacement amount storage unit 62. The entropy storage unit 64 stores the entropy array including entropy values for each elapsed time.

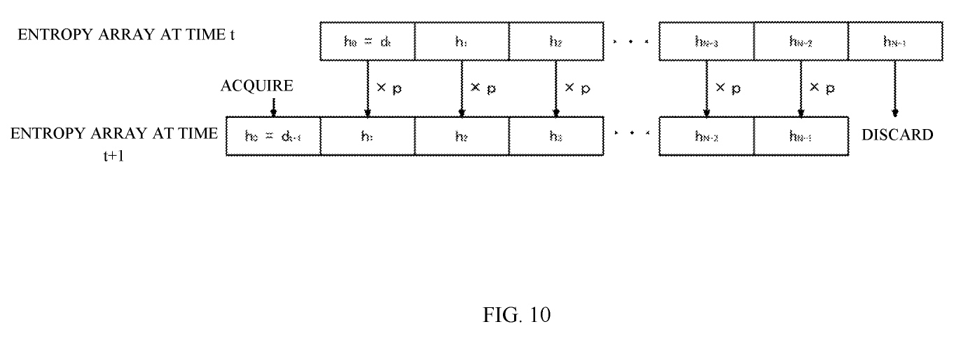

FIG. 10 is a diagram explaining damping calculation of a modification. At time t+1, the representative device determination unit 52 discards the oldest entropy value h_{N-1}in the entropy array for time t and instead stores the most recent displacement amount dₜ₊₁in the entropy array. Moreover, the representative device determination unit 52 multiplies the other entropy values in the entropy array at time t by the same attenuation rate p, and stores the result in the entropy array at time t+1. The attenuation rate p may be determined to an appropriate value based on the developer’s knowledge or experiments using the information processing system 10. For example, the attenuation rate p may be 0.9.

The controller 18 of this modification achieves the same effects as the controller 18 of the second embodiment. Furthermore, according to the controller 18 of this modification, the entropy value may become too small when the elapsed time is long, but on the other hand, it is not necessary to store the attenuation rate array or the displacement amount array, and the amount of data that needs to be stored can be reduced.

Another modification will be described. This modification also relates to the second embodiment. In the second embodiment, the representative analog stick 20 is determined for each of the X-axis and Y-axis directions. As a modification, the representative device determination unit 52 of the controller 18 may determine the single representative analog stick 20 based on both the displacement amount in the X-axis direction and the displacement amount in the Y-axis direction. For example, the representative device determination unit 52 may detect, for each analog stick 20, the distance between the operation amount coordinate position at time t and the operation amount coordinate position at time t+1 on a two-dimensional plane consisting of the X-axis and Y-axis as the displacement amount. Thereafter, as in the second embodiment, the representative device determination unit 52 may determine the operation member with the largest displacement amount within a predetermined time as the representative analog stick 20. As another example of determining a single representative analog stick 20, in the second embodiment, as in the first embodiment (S38 in FIG. 6), it may be determined whether the candidate representative analog stick 20 for the X-axis direction and the candidate representative analog stick 20 for the Y-axis direction match. When both match, the single analog stick 20 may be determined to be the analog stick 20 representing both axes.

Still another modification will now be described. In the first and second embodiments, the controller 18 determines one representative analog stick 20 and generates the operation information based on the operation amount of the one representative analog stick 20 in order to suppress the operation result that is not intended by the user when the plurality of analog sticks 20 are treated as a single input device. As a modification, the controller 18 may not determine one representative analog stick, but may instead generate the operation information based on the average of the operation amounts detected for the plurality of analog sticks 20.

Still another modification will now be described. In the embodiment, a technical concept is proposed that suppresses the operation result that is not intended by the user when the plurality of analog sticks 20 are treated as a single input device. The technical concept of the embodiment is not limited to the analog sticks 20, but can be applied to various operation members in which user input operations are detected as information on a two-dimensional plane. For example, the controller 18 may include a slide operation member instead of the analog stick 20. The slide operation member may be an operation member that allows the user to slide the slider portion from an initial position in any direction or in a predetermined direction. Furthermore, the operation member that detects the user’s input operation as information on a two-dimensional plane may include a trigger button. The trigger button may be a trigger-type button that is supported for rotation and may output a value corresponding to the amount of rotation. The controller 18 may be equipped with a trigger button instead of the analog stick 20. Furthermore, the controller 18 may be equipped with both the analog stick 20 and the trigger button as the operation member.

Still another medication will now be described. In the embodiment, the controller 18 is functioned as the operation processing apparatus that executes data processing to determine the representative analog stick 20 from among the plurality of analog sticks 20. As a modification, an electronic device other than the controller 18 may function as the operation processing apparatus that executes data processing to determine the representative analog stick 20. The other electronic device functioning as an operation processing apparatus may be, for example, an information processing apparatus, a game console, a PC, a server, a tablet terminal, a smartphone, or a head-mounted display.

Any combination of the above-described embodiments and modification is also useful as an embodiment of the present invention. New embodiments resulting from combinations combine the effects of the combined embodiments and modifications. Furthermore, those skilled in the art will understand that the functions to be performed by each component recited in the claims can be realized by each component described in the embodiments and modifications, either individually or in combination.

The technical concepts described in the embodiments and modifications can be expressed as the following technologies.

### [Technology 1]

An operation processing apparatus including:

an acquisition unit that acquires values related to operation amounts of a plurality of operation members detected as information on a two-dimensional plane by a user’s input operation;

a determination unit that determines, when a value related to an operation amount of each of the plurality of operation members is within a range that is considered to be in a stationary state, a representative operation member from among the plurality of operation members based on a predetermined rule; and

a generation unit that generates operation information based on a value related to an operation amount for the representative operation member.

According to this information processing apparatus, when the plurality of operation members are treated as one input device, it is possible to prevent an operation result that is not intended by a user.

### [Technology 2]

The operation processing apparatus according to Technology 1, wherein the acquisition unit repeatedly acquires the values related to the operation amounts of the plurality of operation members, and the determination unit determines an operation member stopped last among the plurality of operation members as the representative operation member based on the repeatedly acquired values related to the operation amounts.

According to this information processing apparatus, an operation member that is likely to be operated next by the user can be set as the representative operation member, making it less likely that the user will feel uncomfortable with the processing result (operation result) according to the user’s operation.

### [Technology 3]

The operation processing apparatus according to Technology 2, wherein when the last-stopped operation member is undetermined, the generation unit generates the operation information based on the result of summing the values related to the operation amounts of the plurality of operation members.

According to this information processing apparatus, the user is less likely to feel uncomfortable with the processing result (operation result) according to the user's operation.

### [Technology 4]

The operation processing apparatus according to Technology 1, wherein the acquisition unit repeatedly acquires the values related to the operation amounts of the plurality of operation members, and the determination unit determines, based on the repeatedly acquired values related to the operation amounts, an operation member having a largest displacement amount within a predetermined time among the plurality of operation members as the representative operation member.

The displacement amount may also be considered the sum of entropy. According to this information processing apparatus, the user often continues to use the operation member last operated by the user. According to this information processing apparatus, the operation member that the user is likely to operate next can be designated as the representative operation member, reducing the user’s discomfort with the processing results (operation results) corresponding to the user’s operation.

### [Technology 5]

The operation processing apparatus according to Technology 4, wherein the determination unit derives, for each operation member, the displacement amount at a plurality of time points within the predetermined time, and derives the displacement amount within the predetermined time for each operation member by summing the displacement amounts at the plurality of time points so that an influence of the displacement amount becomes smaller as the displacement amount becomes older.

The displacement amount at the plurality of time points can be considered entropy, and the displacement amount for each operation member within the predetermined time can be considered the sum of entropies. According to this information processing apparatus, the operation member that the user is likely to operate next can be designated as the representative operation member.

### [Technology 6]

An operation processing method executed by a computer, the method including:

acquiring values related to operation amounts of a plurality of operation members detected as information on a two-dimensional plane by a user’s input operation;

determining, when a value related to an operation amount of each of the plurality of operation members is within a range that is considered to be in a stationary state, a representative operation member from among the plurality of operation members based on a predetermined rule; and generating operation information based on a value related to an operation amount for the representative operation member.

According to this information processing method, when the plurality of operation members are treated as one input device, it is possible to prevent an operation result that is not intended by a user.

### [Technology 7]

A computer program for causing a computer to execute the following functions:

acquiring values related to operation amounts of a plurality of operation members detected as information on a two-dimensional plane by a user’s input operation;

determining, when a value related to an operation amount of each of the plurality of operation members is within a range that is considered to be in a stationary state, a representative operation member from among the plurality of operation members based on a predetermined rule; and generating operation information based on a value related to an operation amount for the representative operation member.

According to this information computer program, when the plurality of operation members are treated as one input device, it is possible to prevent an operation result that is not intended by a user.

### INDUSTRIAL APPLICABILITY

The technology disclosed herein can be applied to operation processing apparatuses, electronic devices, and the like.

### REFERENCE SIGNS LIST

10: information processing system,

12: information processing apparatus,

18: controller,

20: analog stick,

50: operation amount acquisition unit,

52: representative device determination unit,

54: operation information generation unit

1. An operation processing apparatus comprising:
an acquisition unit that acquires values related to operation amounts of a plurality of operation members detected as information on a two-dimensional plane by a user’s input operation;
a determination unit that determines, when a value related to an operation amount of each of the plurality of operation members is within a range that is considered to be in a stationary state, a representative operation member from among the plurality of operation members based on a predetermined rule; and
a generation unit that generates operation information based on a value related to an operation amount for the representative operation member.

2. The operation processing apparatus according to claim 1, wherein the acquisition unit repeatedly acquires the values related to operation amounts of the plurality of operation members and the determination unit determines an operation member stopped last among the plurality of operation members as the representative operation member based on the repeatedly acquired values related to the operation amounts.

3. The operation processing apparatus according to claim 2, wherein the generation unit generates the operation information based on a result of summing the values related to the operation amounts of the plurality of operation members.

4. The operation processing apparatus according to claim 1, wherein the acquisition unit repeatedly acquires the values related to the operation amounts of the plurality of operation members and the determination unit determines, based on the repeatedly acquired values related to the operation amounts, an operation member having a largest displacement amount within a predetermined time among the plurality of operation members as the representative operation member.

5. The operation processing apparatus according to claim 4, wherein the determination unit derives, for each operation member, a displacement amount at a plurality of time points within the predetermined time.

6. A computer-implemented method for operation processing comprising:
acquiring values related to operation amounts of a plurality of operation members detected as information on a two-dimensional plane by a user’s input operation;
determining, when a value related to an operation amount of each of the plurality of operation members is within a range that is considered to be in a stationary state, a representative operation member from among the plurality of operation members based on a predetermined rule; and
generating operation information based on a value related to an operation amount for the representative operation member.

7. A non-transitory, computer-readable medium storing one or more instructions executable by a computer system to perform one or more operations comprising:
acquiring values related to operation amounts of a plurality of operation members detected as information on a two-dimensional plane by a user’s input operation;
determining, when a value related to an operation amount of each of the plurality of operation members is within a range that is considered to be in a stationary state, a representative operation member from among the plurality of operation members based on a predetermined rule; and
generating operation information based on a value related to an operation amount for the representative operation member.

8. The operation processing apparatus according to claim 3, wherein the generation unit generates the operation information based on the result of summing the values related to the operation amounts of the plurality of operation members when the operation member stopped last is undetermined.

9. The operation processing apparatus according to claim 5, wherein the determination unit derives the displacement amount within the predetermined time for each operation member by summing displacement amounts at the plurality of time points so that an influence of the displacement amount becomes smaller as the displacement amount becomes older.

10. The computer-implemented method according to claim 6, wherein an acquisition unit repeatedly acquires the values related to operation amounts of the plurality of operation members and a determination unit determines an operation member stopped last among the plurality of operation members as the representative operation member based on the repeatedly acquired values related to the operation amounts.

11. The computer-implemented method according to claim 10, wherein a generation unit generates the operation information based on a result of summing the values related to the operation amounts of the plurality of operation members.

12. The computer-implemented method according to claim 6, wherein an acquisition unit repeatedly acquires the values related to the operation amounts of the plurality of operation members and a determination unit determines, based on the repeatedly acquired values related to the operation amounts, an operation member having a largest displacement amount within a predetermined time among the plurality of operation members as the representative operation member.

13. The computer-implemented method according to claim 12, wherein a determination unit derives, for each operation member, a displacement amount at a plurality of time points within the predetermined time.

14. The computer-implemented method according to claim 11, wherein the generation unit generates the operation information based on the result of summing the values related to the operation amounts of the plurality of operation members when the operation member stopped last is undetermined.

15. The computer-implemented method according to claim 13, wherein the determination unit derives the displacement amount within the predetermined time for each operation member by summing displacement amounts at the plurality of time points so that an influence of the displacement amount becomes smaller as the displacement amount becomes older.

16. The non-transitory, computer-readable medium according to claim 7, wherein an acquisition unit repeatedly acquires the values related to operation amounts of the plurality of operation members and a determination unit determines an operation member stopped last among the plurality of operation members as the representative operation member based on the repeatedly acquired values related to the operation amounts.

17. The non-transitory, computer-readable medium to claim 16, wherein a generation unit generates the operation information based on a result of summing the values related to the operation amounts of the plurality of operation members.

18. The non-transitory, computer-readable medium according to claim 7, wherein an acquisition unit repeatedly acquires the values related to the operation amounts of the plurality of operation members and a determination unit determines, based on the repeatedly acquired values related to the operation amounts, an operation member having a largest displacement amount within a predetermined time among the plurality of operation members as the representative operation member.

19. The non-transitory, computer-readable medium according to claim 18, wherein a determination unit derives, for each operation member, a displacement amount at a plurality of time points within the predetermined time.

20. The non-transitory, computer-readable medium according to claim 17, wherein the generation unit generates the operation information based on the result of summing the values related to the operation amounts of the plurality of operation members when the operation member stopped last is undetermined.
